(19) United States
(12) Patent Application Publication
(10) Pub. No.: US 2002/0017638 A1
(43) Pub. Date: Feb. 14, 2002

(54) Window opener

(76) Inventor: James R. Suiter, Omaha, NE (US)

Correspondence Address: KENYON & KENYON, 1500 K STREET, N.W., SUITE 700, WASHINGTON, DC, 20005, US

(21) Appl. No.: 09/902,635

(22) Filed: Jul. 12, 2001

Related U.S. Application Data
(63) Continuation-in-part of application No. 09/578,914, filed on May 26, 2000.

(51) Int. Cl. B66F 3/00

(52) U.S. Cl. 254/116

(57) ABSTRACT

A window opener is provided. In one embodiment the window opener may include a handle of predetermined width and length, the handle having a grabbing tip and a pivot pin. The window opener may also include a pole, repositionable with respect to the handle, wherein the pole has a first end, a second end, and a cleat in physical communication with the pivot pin. In another embodiment a method of sliding a stuck window within a window frame having a sash is provided. This method may include providing a handle having a proximate end, a distal end, and an opening with a pivot point. It also may include inserting a rigid pole having a plurality of cleats through the opening of the handle, aligning the cleat of the rigid pole with the pivot point of the handle, and applying force to the stuck window section by pivoting the handle in the cleat.

### RELATED APPLICATIONS

This Application claims the benefit of and is a continuation-in-part of prior application Ser. No. 09/578,914 filed May 26, 2000.

### FIELD OF THE INVENTION

The present invention is directed to the opening of windows. More specifically the present invention regards the opening of double and triple hung windows that are painted shut or otherwise not opening properly.

### BACKGROUND OF THE INVENTION

Double and triple hung windows are common aspects of modern architecture. They are used in both residential and commercial buildings due to, among other things, their aesthetic appeal and their ease of operation.

A common double hung window includes two moveable glass sections, each containing a sheet or pane of glass placed within a wooden sash. These sections are most often placed parallel and adjacent to one another within a frame and are designed to slide up and down within the frame. Alternatively, instead of placing only one sheet of glass within each section, several sheets or panes of glass are sometimes placed within each section. When several panes of glass are placed inside a section, the glass panes are placed within and separated by vertical and horizontal mullions attached to the wooden sashes. Like the single pane sections these multiple pane sections are also designed to slide up and down within the frame.

The frames themselves often contain two separate channels, one channel for each of the sections to slide within. The overall width or thickness of the frame is typically wider than the combined thickness of both sections in order to form a ledge around the entire perimeter of the frame.

These sections are intended to move up and down within the frame with only minimal force. On occasion, however, more than minimal force is required to slide the sections up and down within the channels of the frame. In fact, in some instances, the sections become fixed within the channel, refusing to move either up or down. This sticking or immobilization is sometimes caused by the swelling or warping of the frames and the sashes. Alternatively, this sticking or immobilization can also be caused by foreign materials which have glued the sections in place. For example, when made of wood, the sashes and frames are often painted to protect them from their environment. When this paint dries it behaves like a glue to lock the section within the frame. If the paint adhering the sashes of the sliding sections to the frame or to one another has cured the amount of force necessary to unstick the sections can be significant. The amount of force required to unstick the windows can increase further still when the sections have been painted shut a few times without being “unstuck” between coats of paint.

Unsticking the windows, to allow the free travel of the sections within the frame, can be a time consuming and laborious process. In one known method illustrated in FIG. 1 a hand-held paint scraper 100 is hammered by a hammer 110 into the crevice between the border 130 and the sash 120 of a section 170. The section 170 located within the channel 140 also has a mullion 15. The paint scraper 100 is then removed from this crevice, repositioned, and again hammered between the border 130 and the sash 120 of the section 170, this time at a different location. This hammering and removal continues around the entire perimeter of the section until the seal is broken and the section can again travel up and down within the channel 140. As is evident, this is a time-consuming, inefficient, and risky process; one that can result in the glass within the section being broken by the impact force of the hammer 110 against the scraper 100 or by the vibratory shocks of the hammer's impact resonating through the section 170 or the frame 160 after each blow.

It would, therefore, be desirable to have a process that can unstick windows in an efficient and effective manner. One that is simple to perform and one that does not risk damaging the window from the impact required to open the window.

### SUMMARY OF THE INVENTION

A window opener is provided. In one embodiment the window opener may include a handle of predetermined width and length, the handle having a grabbing tip and a pivot pin. The window opener may also include a pole, repositionable with respect to the handle, wherein the pole has a first end, a second end, and a cleat in physical communication with the pivot pin.

In another embodiment a method of sliding a stuck window within a window frame having a sash is provided. This method may include providing a handle having a proximate end, a distal end, and an opening with a pivot point. It also may include inserting a rigid pole having a plurality of cleats through the opening of the handle, aligning the cleat of the rigid pole with the pivot point of the handle, and applying force to the stuck window section by pivoting the handle in the cleat.

### BRIEF DESCRIPTION OF THE DRAWINGS

FIG. 1 illustrates a known process for opening stuck windows.

FIG. 2 is a side view of a first embodiment of the present invention.

FIG. 3 is a side view of a component from a second embodiment of the present invention.

FIG. 4 is a top view of the component in FIG. 3 viewed from line 4-4.

FIG. 5 is a top view of a component from a third embodiment of the present invention.

FIG. 6 is an enlarged view of a component from the embodiment illustrated in FIG. 2.

FIG. 7 is a top view of the component in FIG. 6.

FIG. 8 is a top view of another component from the embodiment illustrated in FIG. 2.

FIG. 9 is a side view of the component in FIG. 8.

FIG. 10 is a bottom view of the component in FIG. 8.

FIG. 11 is a side view of a fourth embodiment of the present invention before a cleat has been placed underneath a window mullion.

FIG. 12 is a side view of a fourth embodiment after the cleat has been placed underneath a window mullion.

FIG. 13 is a front view of the first embodiment illustrated in FIG. 2 when used in accordance with the present invention.

FIG. 14 is a perspective view of individual components used in a fifth embodiment of the present invention.

FIG. 15 is an assembled perspective view of the individual components from FIG. 14.

FIG. 16 is a perspective view of the assembled components from FIG. 15 being used to open a window.

FIG. 17 is a side view of a sixth embodiment of the present invention.

FIG. 18 is a perspective view of the embodiment from FIG. 17 being employed to open a window.

FIG. 19 is a side view of the handle from FIG. 17.

FIG. 20 is a top view of the handle from FIG. 17.

FIG. 21 is a side view of the rigid pole from FIG. 17.

FIG. 22 is a top view of the rigid pole from FIG. 17.

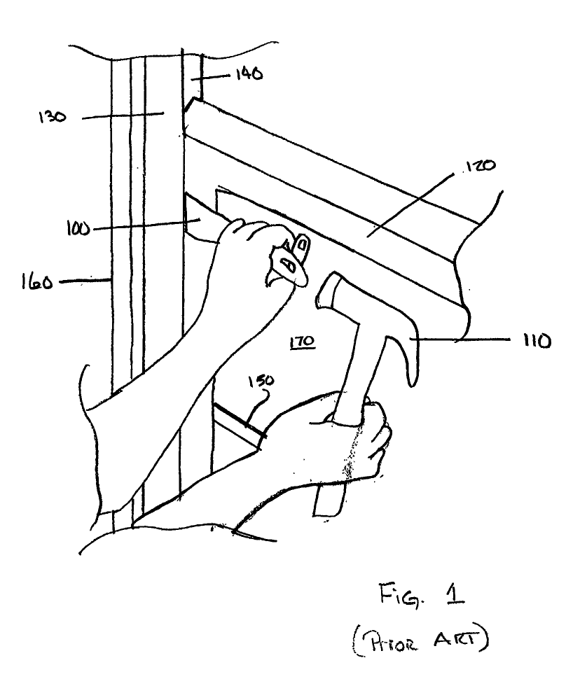

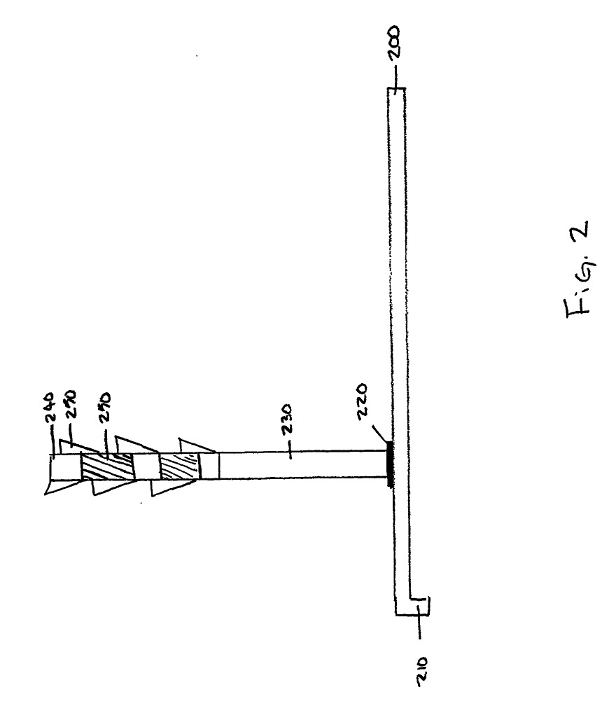

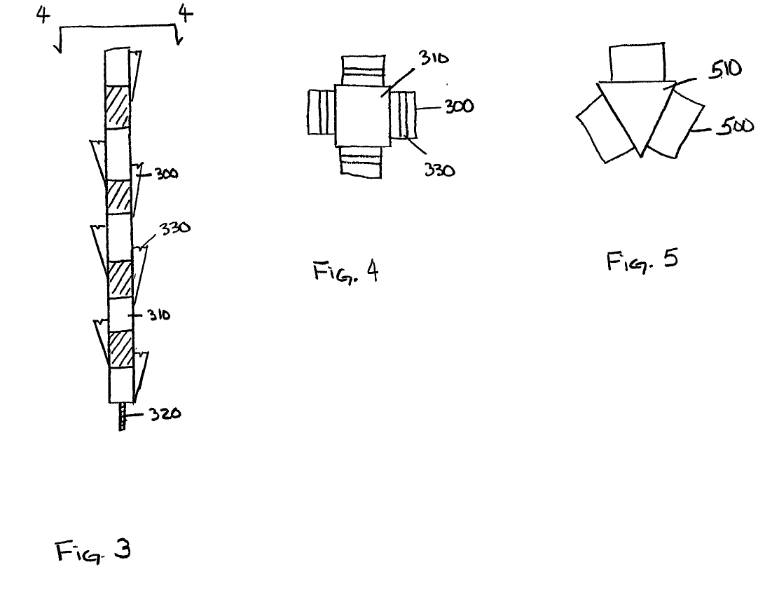

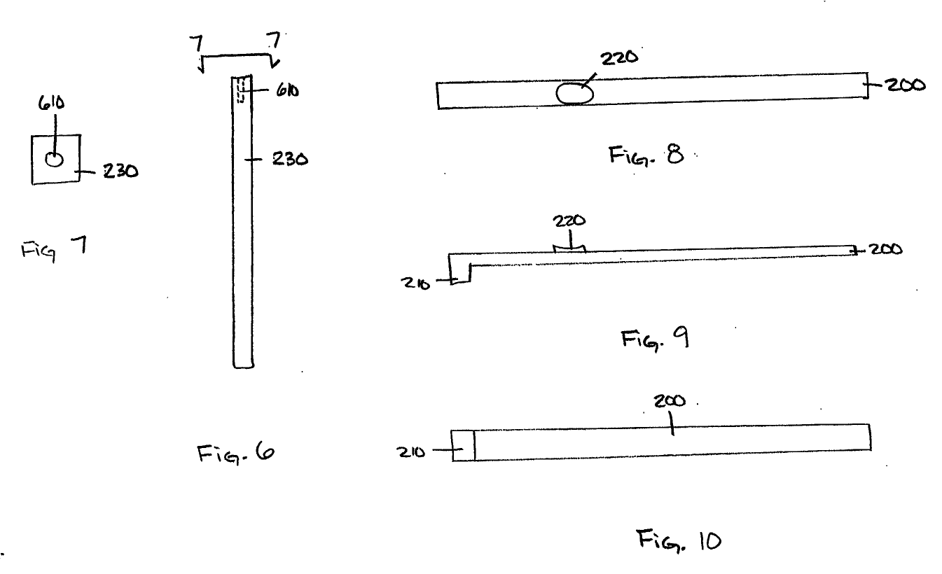

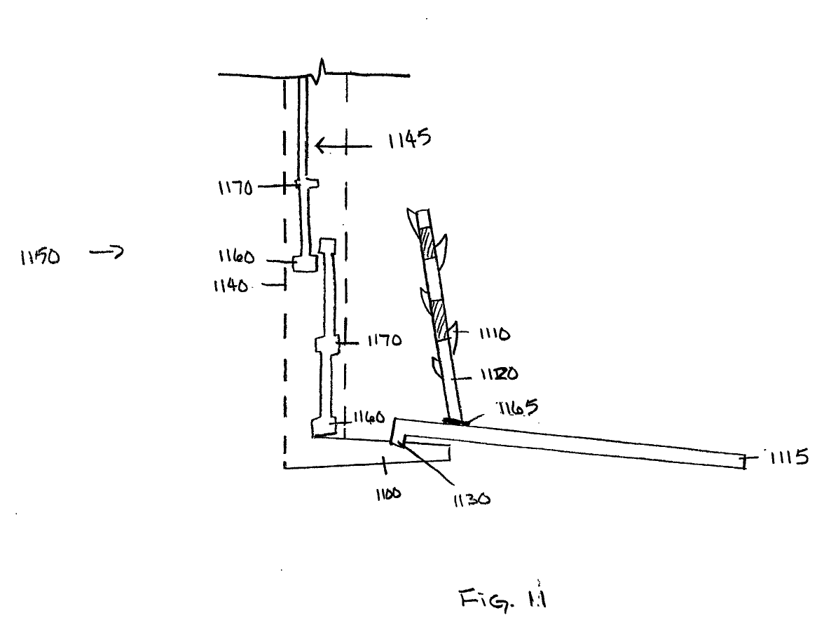

### DETAILED DESCRIPTION

FIG. 2 is a side elevation of a first embodiment of the present invention. As is evident FIG. 2 illustrates a handle 200 having a fulcrum or foot 210 at one of its ends. FIG. 2 also illustrates a bracket 220 located on top of the handle 200, an extension pole 230 positioned in the 20 bracket 220, a rigid pole 240 having cleats 250 attached to its exterior and being positioned on top of and firmly connected to the extension pole 230. The extension pole 230 is resting in the bracket 220 and can be removed from the bracket 220 by simply lifting it out of the bracket 220. The bracket 220 may be sized to allow the end of the extension pole 230 to pivot around within the bracket 220. While the bracket 220 is illustrated as a separate component mounted on top of the handle 200 it may also be an integral depression or notch formed in the handle 200.

In this embodiment each of the components: the rigid pole 240; the cleats 250; the extension pole 230; the foot 210; and, the handle 200 are made from a rigid polymer. They can, alternatively, be made from wood, from a combination of wood and plastic, or from any other rigid material. In addition, while the cleats 250 are illustrated with an identical size and shape, the cleats 250 may, alternatively, be different sizes or shapes. Moreover, while the rigid pole 240 and the extension pole 230 are both illustrated in this embodiment and in subsequent embodiments as having a fixed length, they can be adjustable to vary in length. For example, both the rigid pole 240 and the extension pole 230 can have locking telescoping elements which provide for the adjustment and readjustment of the length of both members.

As will be set out in more detail below, this embodiment of the invention is utilized to open stuck windows by placing the foot 210 of the handle 200 on the sill of a window (not shown). The extension pole 230, having the rigid pole 240 attached to it, is then placed on the handle 200, in the bracket 220. The cleat 250 closest to a mullion or border of the immobilized window section is then placed underneath the mullion of that section. The handle is then lifted, urging the cleat up and into the mullion, thereby forcing the section up and open—an elegant and efficient process.

FIG. 3 illustrates a second embodiment of the present invention. In FIG. 3 a rigid pole 310 is shown having cleats 300 and a screw 320. In this embodiment the cleats 300 have been integrally formed as part of the rigid pole 310, alternatively the cleats 300 could have been firmly secured to the rigid pole 310 with glue or anchors of some kind. The screw 320 is anchored into the end of the rigid pole 310 and is sized to be able to firmly anchor and support the rigid pole 310 when it is placed into the extension pole (not shown in this illustration). The screw 320 may be removable from the bottom of the rigid pole 310 so that the rigid pole 310 can be used without the extension pole as well. The cleats 300 in this embodiment are shown with grooves or indentations 330. These indentations 330 are “V” shaped and are sized to assist in grasping the mullion or border of a sticking section. FIG. 3 also illustrates that the top of each of the cleats 300 may be a different distance from the top of the rigid pole 310. This staggered spacing provides adjustment in the position of the cleat 300 relative to the mullion or border of the window section. By simply rotating the rigid pole 310, a different cleat 300, located at a different height on the rigid pole 310, will be facing the window section and will be available for use in lifting the window section.

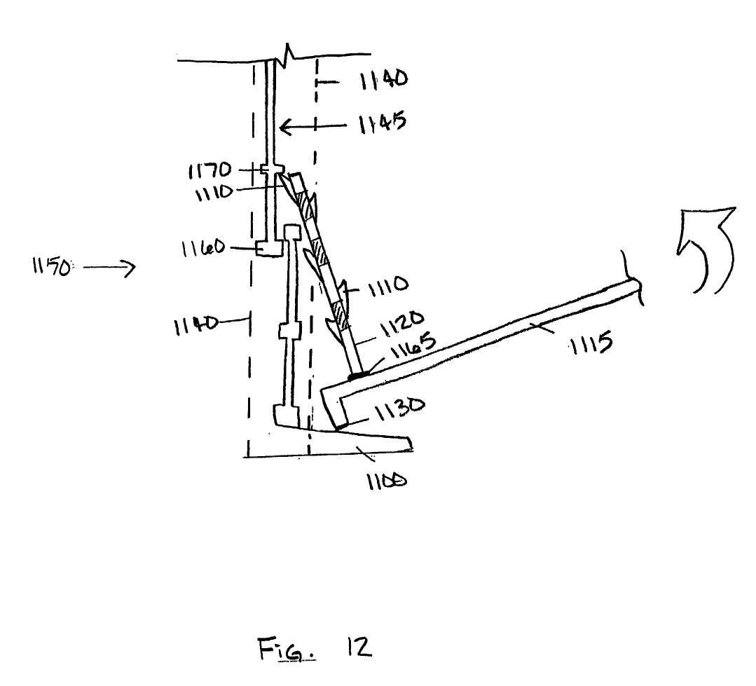

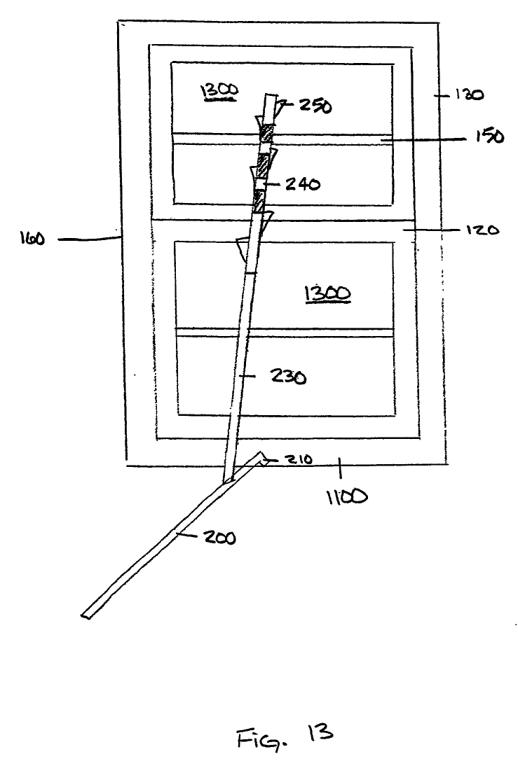

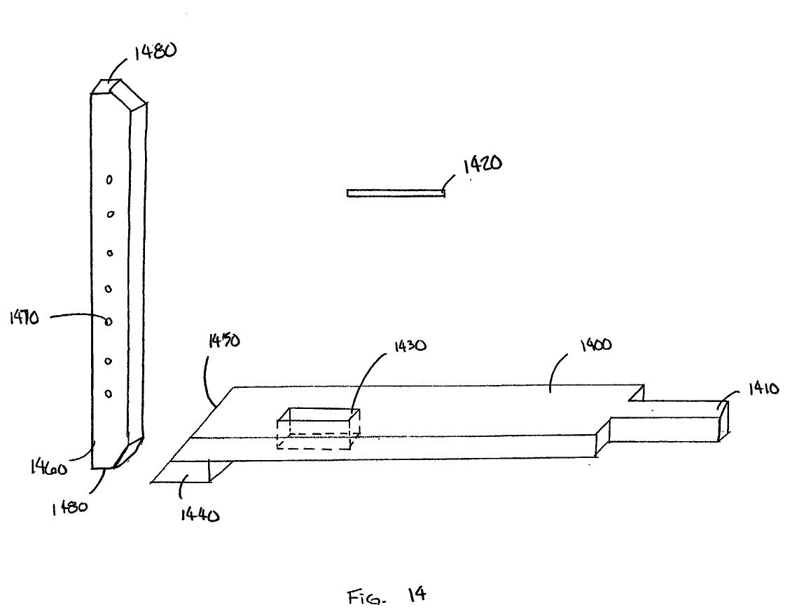

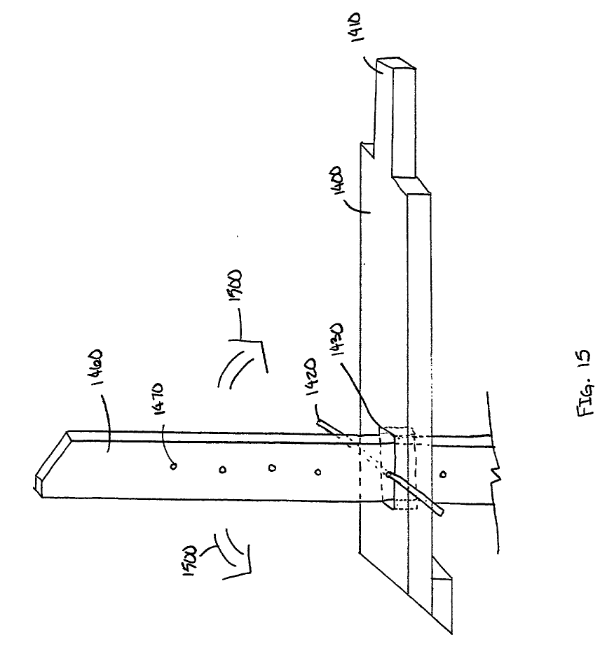

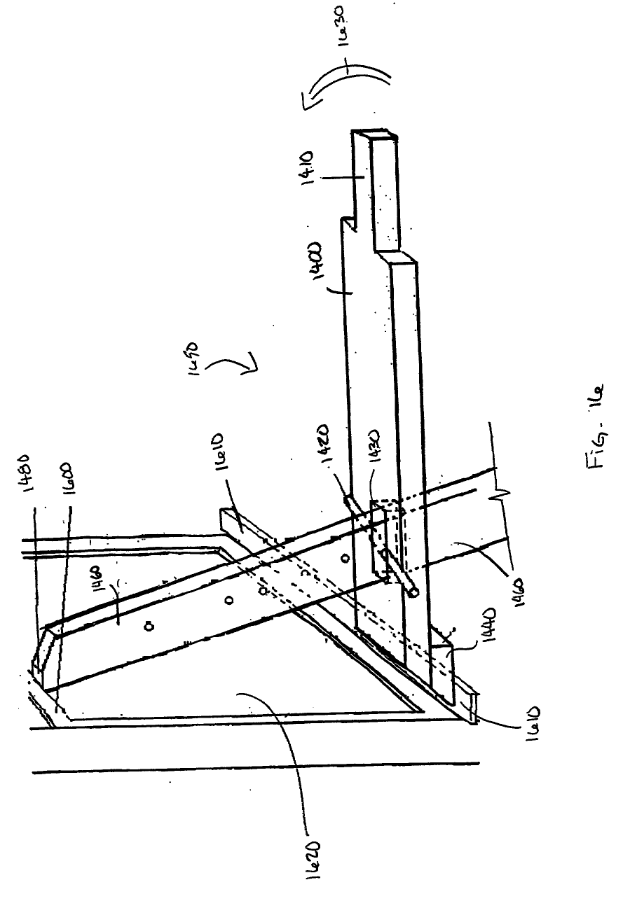

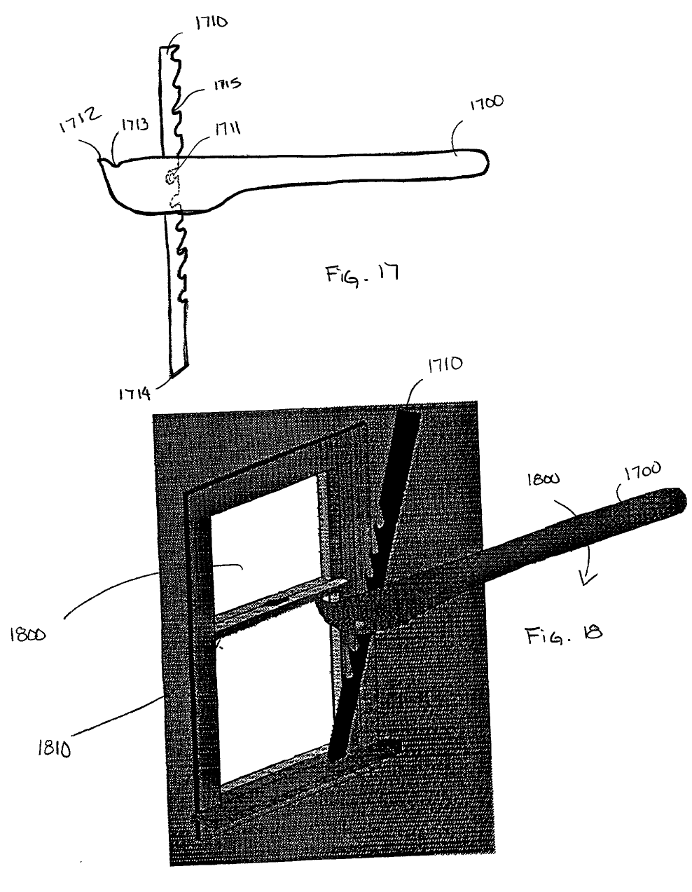

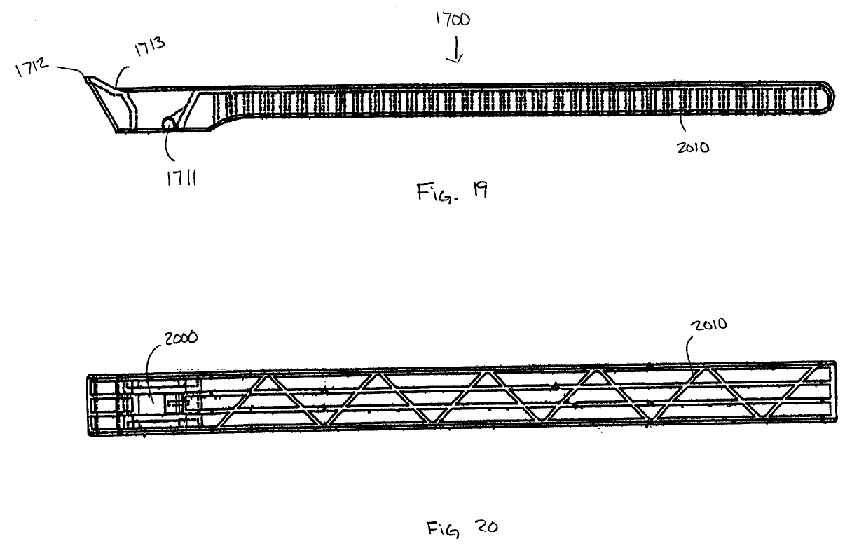

FIG. 4 is a view from line 4-4 of FIG. 3. The cleats 300, their indentations 330, and the rigid pole 310 are clearly apparent in this illustration. As is also evident in this illustration the rigid pole 310 may be rectangularly shaped with the cleats 300 being placed on each side of the rigid pole 310.

FIG. 5 is a top view of a rigid pole 510 in a third embodiment of the present invention. As is evident, the rigid pole 510 has a triangular cross-section; however, while both a triangular and a rectangular cross-section have been illustrated, the cross-sectional profile of the rigid pole 510 can vary widely. For example, the rigid pole can also be octangular or hexagonally shaped.

FIG. 5 also illustrates the cleats 500 mounted on each side of the rigid pole 510. The cleats 500, illustrated in this third embodiment, are not indented as shown in the embodiment of FIG. 3.

FIG. 6 is an enlarged view of the extension pole 230 of FIG. 2. This enlarged view illustrates the threaded receptacle 610, which may be sized to accept the screw from the rigid pole (which is not shown in this illustration but is illustrated in FIG. 3). The extension pole 230 may have the same exterior shape as the rigid pole that it will be connected too. When the rigid pole (not shown) and the extension pole 230 are connected end to end their surfaces may be flush with one another.

FIG. 7 is a view taken along line 7-7 of FIG. 6. As can be seen the cross-section of the extension pole 230 is rectangular in shape. As can also be seen the threaded receptacle 610 is centered in the end of the extension pole 230 in this embodiment.

FIGS. 8-10 are different views of the handle 200, foot 210, and bracket 220 of the embodiment illustrated in FIG. 2. In FIG. 8, which is a top view of the handle 200, the bracket 220 is shown closer to the foot 210 end of the handle 200 although it can also be positioned in other locations on the handle as well. The bracket 220 is also shown to be oblong in shape and located between the two sides of the handle 200. In FIG. 9, which is a side view of the handle 200, the top of the bracket 220 is shown. It is evident that the bracket 220 has a depression in it. This depression may be sized to accept either the end of the extension pole or the end of the rigid pole. FIG. 10 is a bottom view of the handle 200. This view illustrates that the foot 210 can be rectangularly shaped.

FIG. 11 illustrates a fourth embodiment of the present invention before it is used to open a window 1150. This illustration shows a foot 1130 resting on top of a sill 1100 of a window frame 1140. Inside the window 1150 are sections 1145 that slide up and down within the channel (not shown) of the frame 1140. These sections contain sashes 1160 and mullions 1170. As is evident no extension pole is required in this embodiment. Instead, the screw in the end of the rigid pole has been removed and the rigid pole 1120 has been placed directly into the bracket 1165 on top of the handle 1115.

The cleats 1110 in this embodiment do not have flat top surfaces and indentations as shown in previous embodiments, instead the top surface of the cleats 1110, in this fourth embodiment, are inclined and form an acute angle with the rigid pole 1120.

FIG. 12 illustrates how the fourth embodiment may be used to open a stuck window. As shown in FIG. 12 the rigid pole 1120 is lifted up and into the mullion 1170 a component of the widow section 1145. The cleat 1110, positioned below the mullion 1170, presses on the mullion 1170 during the uplifting stroke to create an upward lifting force on the mullion 1170. This upward lifting force pushes the window section 1145 up, freeing it from its stuck position. If the section 1145 does not become dislodged after one lifting cycle, the window opener can be placed on a different point of the sill 1100 to engage a different point of the mullion 1170 to be urged upwards. Due to the rigid but lightweight design, the window opener is readily moved from point to point on the window sill.

As noted earlier the rigid member 1120 may contain cleats 1110 on each of its sides. These cleats 1110 may be at a different elevation on the rigid member relative to the top of the rigid pole 1120. As required, depending on the height of the mullion 1170 above the sill 1100, the rigid pole 1120 would be rotated to align the most appropriate cleat 1110 directly below the mullion 1170. Alternatively, instead of positioning the cleat below the mullion, the cleat 1110 could be positioned below the sash 1160 if the sash 1160 was more accessible or more sturdy than the mullion 1170. Whether the cleat was placed below the mullion 1170 or the sash 1160, the process for raising the window section 1145 would proceed as described above. Alternatively, if the rigid pole 1120 did not reach the mullion 1170 or the sash 1160 of the sticking window section 1145, an extension pole may be added to the bottom of the rigid pole 1120 to better position the cleat 1110 below the sticking section 1145.

FIG. 13 illustrates the first embodiment illustrated in FIG. 2 as used to open a sticking window. As is evident the foot 210 of the handle 200 is resting on the sill 1100, the extension pole 230 has been screwed to the rigid pole 240 in order to position the rigid pole 240 next to the section 1300 to be opened or slid and the rigid pole 240 is tipping in towards the mullion 150 of the section 1300 to be slid. One of the cleats 250, located on the rigid pole, has been placed immediately below the mullion 150 of the section 1300. In use, the handle 200 is lifted up, pushes the cleat 250 up against the mullion 150 and, thereby, urges the section up. If the section 1300 does not open after one lifting cycle the window opener will be repositioned on the sill 1100 in order to place a lifting force on a different portion of the mullion 150 or alternatively on the border 120 instead.

FIG. 14 is a perspective view of components utilized in a fifth embodiment of the present invention. Evident in FIG. 14 is a handle 1400 having a grasp 1410, a channel 1430, a beveled edge 1450, and a foot 1440. As can be seen the channel 1430 in the handle 1400 is closer to the beveled edge 1450 side of the handle 1400 than the grasp 1410 side of the handle 1400. As can also be seen the channel 1430 completely penetrates through the handle 1400.

Also evident in FIG. 14 is a solid cylindrical pin 1420. This pin 1420, like the handle and the pole 1460, is preferably made from a rigid plastic but may also be made from other materials such as wood, metal alloys, a combination of these materials, or any other suitable material. The pin 1420 is smaller in diameter than the openings 1470 located along the length of the pole 1460 so that the pin 1420 may be readily slid in and out of the openings 1470. The pin 1420 is not only longer than the width of the pole 1460, it is also longer than the width of the channel 1430. Consequently, when the pin 1420 is placed in an opening 1470 of the pole 1460 the pin 1420 will protrude from both sides of the opening 1470 and, when the pole 1460 is placed into the channel 1430, will prevent the pole 1460 from sliding further through the channel 1430. The pole 1460 will thus be suspended in the channel by the pin 1420. As is evident, the pole 1460 contains a sash seat 1480 on both of its ends so that the pole 1460 may be slid into channel 1430 from either end.

Alternatively, rather than having the openings completely penetrate the pole as described above, the openings, aligned with one another on opposite sides of the pole, may only penetrate a portion of the pole. In this sixth embodiment, rather than using a single pin, two would be needed, one for each side of the pole. In use, once the two pins were inserted into the pole, the pins would act as a support for the pole when the pole was inserted into the channel of the handle, like the embodiments described above.

FIG. 15 is a perspective view of the components from FIG. 14 after they have been assembled. Clearly evident in FIG. 15 is the pin 1420 located within one of the openings 1470 of the pole 1460. As can be seen and as described above, the pin 1420 supports the pole 1460 within the channel 1430. Arrows 1550 of FIG. 15 make evident that the pole 1460 is free to pivot back and forth when it is paced in the channel 1430. This pivoting about the pin 1420 provides a range of adjustment for the pole 1460 when it is used to open a window.

FIG. 16 is a perspective view of the assembled components from FIG. 15 being utilized to open a stuck window. The window in FIG. 16 contains a sill 1610, a pane 1620 of glass, and a sash 1600. As can be seen the sash seat 1480 of the pole 1460 is positioned underneath the sash 1600, a component of the window, while the foot 1440 of the handle 1400 is resting on the sill 1610. The arrow 1630 indicates the direction of movement of the grip 1410 when the window opener 1650 is utilized to open a window. As the grip 1410 is lifted, the pole 1460 and, concomitantly, the sash seat 1480, will be urged up towards the sash 1600 of the window. As described above, this upward lifting movement can be repeated at several locations of the window until the window has been dislodged from its frozen position.

FIG. 17 is a side view of a sixth embodiment of the present invention. In this embodiment the rigid pole 1710 is preferably configured to rest on the sash of a window while the handle 1700 is preferably configured to contact the stuck window section to be opened. In FIG. 17 a handle 1700 having a pivot pin 1711, a recess 1713, and a grabbing tip 1712 can be seen. A rigid pole 1710 having a plurality of cleats 1715 along one of its sides and having a sash seat 1714 at its lower end can also be seen in FIG. 17. The pivot pin 1711 in this embodiment may be sized to fit within one of the cleats and allow the handle 1700 to pivot up and down at this point. The actual configuration of the pivot pin and the cleat can take innumerable configurations including a cylinder and accommodating groove, a polygon and accommodating channel, and a sphere and accommodating pocket.

In use the rigid pole 1710 may be slid through an opening in the handle 1700 until one of the cleats engages the pivot pin 1711 of the handle 1700. The sash seat 1714 may then be placed on the sash of a window and the end of the handle 1700 may then be depressed such that the gabbing tip 1712, the recess 1713 or both engages the window section to be opened. The plurality of cleats on the rigid pole provides for adjustability to accommodate different window sizes as well as providing for adjustments to be made during the lifting process as the window section is lifted away from the grabbing tip 1712.

FIG. 18 is a perspective view of the handle and rigid pole of FIG. 17 as employed in accord with an embodiment of the present invention. As can be seen the sash seat 1714 is resting on the sash of the window and the pivot pin is resting in one of the cleats of the rigid pole. As described above, by pushing down on the handle 1700, in the direction of arrow 1800, an amplified upward force will be placed on the mullion 1810 of the moveable window sections 1800. In order to open a stuck window section, the rigid pole may be positioned at numerous points along the sash in order to apply forces to different parts of the mullion 1810. Moreover, as the window begins to open, if necessary, the handle 1700 and pivot pin 1711 may be repositioned in a different cleat of the rigid pole to accommodate the partially slid section 1800.

Alternatively, rather than resting the sash seat 1714 on the sash of the window it may also be placed on other portions of the window and any other nearby positions. Moreover, it may be oriented in any direction as well. In each of these alternative positions it is preferable, however, to place the sash seat 1714 in contact with a rigid material that will adequately resist the forces being exerted against it during the opening process. While a single length pole is shown in FIG. 18 the pole may also have an adjustable length capable of being lengthened or shortened as necessary.

The handle and rigid pole assembly may be made from numerous materials including plastic, metal, reinforced fiberglass, rigid carbon composites, and other suitable materials. FIGS. 19 and 20 show a side and top view of the handle 1700 from FIG. 17. The handle 1700 in this embodiment has been made from plastic although it may have been made from the other materials described above as well as any other suitable material. The handle and rigid pole may also have numerous cross-sectional configurations including various polygonal (e.g., square and rectangular) cross-sections and various round (e.g. circular and elliptical) cross-sections.

The pivot pin 1711, recess 1713, reinforcement struts 2010, grabbing tip 1712, and opening 2000 can be clearly seen in these two figures. As can also be seen the pivot pin is positioned in the opening 2000 such that the cleats of the rigid pole being placed into the opening may come in contact with and grasp it, as necessary, during the opening process.

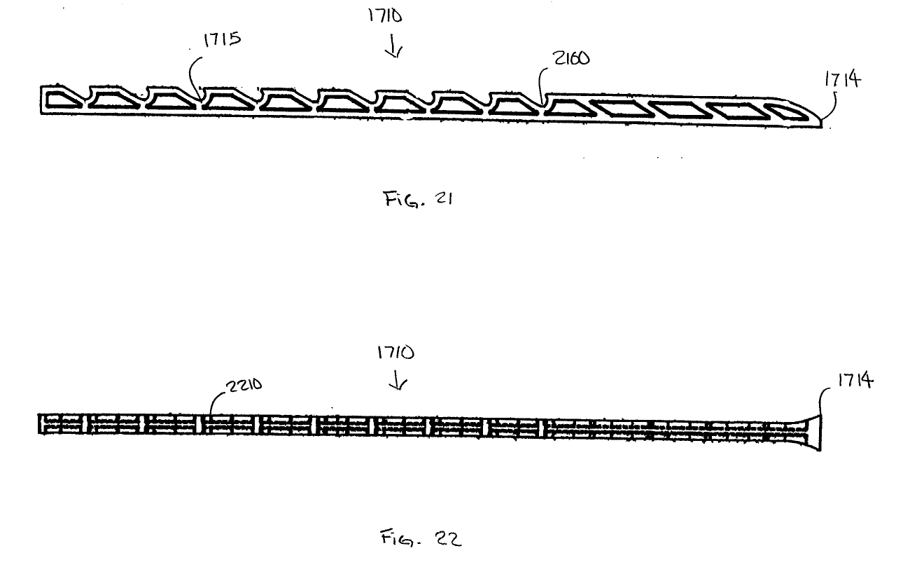

FIGS. 21 and 22 show side and top views, respectively, of the rigid pole 1710. Like the handle 1700, the rigid pole 1710 also contains reinforcing struts 2210 to provide added rigidity without a substantial addition of weight or bulk. While reinforcing struts 2210 are used in this embodiment other configurations with alternative designs are also plausible.

In these figures the sloped and fanning configuration of the sash seat 1714 is clearly visible. In addition to providing a base from which to work from, the sash seat may also be used to pry open windows after they have been opened by the rigid pole and handle. In other words, in this alternative embodiment, after the window has been moved by the handle and pole assembly, the pole may be disconnected from the handle and the pole may be used as a crow bar to continue to open the window.

A window opener is described above. The disclosed embodiments are illustrative of the various ways in which the present invention may be practiced. Other embodiments, not discussed above, can also be implemented by those skilled in the art without departing from the spirit and scope of the present invention.

What is claimed is:

1. A window opener for opening stuck windows comprising:
a handle having a predetermined width and length, the handle also having a grabbing tip and a pivot pin; and
a pole with a first end and a second end,
the pole having a cleat,
the cleat in physical communication with the pivot pin,
the pole being repositionable with respect to the handle.

2. The window opener of claim 1 wherein the second end of the pole has a sash seat.

3. The window opener of claim 1 wherein the handle also has an opening, the opening sized to allow the pole to pass through it.

4. The window opener of claim 3 wherein the sash seat has a contoured configuration and wherein the pole has a second cleat.

5. A window opener to open a stuck window comprising:
a rigid pole having an exterior perimeter, a proximate end and a plurality of cleats; and
a handle having a pivot pin, a grabbing tip, and an opening sized to allow the rigid pole to slide within it,
the pivot pin of the handle in contact with one of the cleats.

6. The window opener of claim 5 wherein the rigid pole has a sash seat.

7. The window opener of claim 5 wherein the cross-section of the perimeter of the rigid pole and the cross-section of the perimeter of the handle form the shape of a polygon.

8. The window opener of claim 5 wherein the cleats are of substantially the same size and shape.

9. The window opener of claim 6 wherein the contoured foot forms the shape of a wedge.

10. The window opener of claim 5 wherein said first cleat is wedge shaped.

11. The window opener of claim 5 wherein the handle and the rigid pole are made from a rigid polymer.

12. The window opener of claim 5 wherein the length of the rigid pole is adjustable.

13. A method of sliding a stuck window within a window frame having a sash comprising:
providing a handle having a proximate end and a distal end, the handle also having an opening with a pivot point;
inserting a rigid pole through the opening of the handle, the rigid pole having a plurality of cleats;
aligning the cleat of the rigid pole with the pivot point of the handle; and
applying force to the stuck window section by pivoting the handle in the cleat.

14. The method of sliding a stuck window of claim 13 further comprising:
raising the proximate end of the handle;
repositioning the pin into a different cleat; and
applying force to the stuck window section by pivoting the handle in the cleat.

15. The method of sliding a stuck window of claim 13 further comprising:
inserting a sash seat portion of the rigid pole into an opening created by applying force to the stuck window.

16. A window opener comprising:
a handle having an opening and a pivot pin; and
a rigid pole having a first end and a second end,
the second end having a sash seat, the rigid pole having a means for pivotally connecting the rigid pole to the handle.
